(19) United States
(12) Patent Application Publication
(10) Pub. No.: US 2019/0086665 A1
(43) Pub. Date: Mar. 21, 2019

(54) Persistence of Vision Augmented Reality Display

(71) Applicant: Microsoft Technology Licensing, LLC, Redmond, WA (US)

(72) Inventor: Andriy PLETENETSKYY, Mountain View, CA (US)

(21) Appl. No.: 15/710,210

(22) Filed: Sep. 20, 2017

(51) Int. Cl. G02B 27/01; G06T 19/00; G06F 3/01; H04N 13/04

(52) U.S. Cl. CPC G02B 27/0172; H04N 13/049; G06F 3/011; G06T 19/006

(57) ABSTRACT

A movement based display device configured to display full images to a user by moving light emitters through a user's field of view. The movement based display device includes a first movable member. The movement based display device further includes a first light emitter array, comprising a plurality of light emitters, coupled to the first movable member. The first light emitter array is configured to output light from the light emitters dependent on a position of the first movable member. The movement based display device further includes a first lens array. The first lens array is coupled to the first light emitter array. The first lens array comprises lenses configured to direct light into a first aperture, such as a user's eye.

### BACKGROUND

### Background and Relevant Art

Recently, there has been a surge in interest in virtual reality (VR), mixed reality (MR), and augmented reality (AR) devices. Many of these devices make use of user-worn headsets that are able to project images onto a user's eyes to create two-dimensional or three-dimensional images displayed to a user. Often, these headsets are bulky and cumbersome to wear. This can be caused in some devices due to the inefficient nature of projectors and optical devices in the headsets. In particular, the inefficiencies of projectors and waveguides results in the need to use higher power for transmission, and the corresponding need to have bulky cooling systems to dissipate excess generated heat. Additionally, in some devices even the weight of the projectors and waveguides create a significant amount of bulk and weight. This can make such headsets difficult to wear and use for long periods of time.

Additionally, such devices often have a limited field of view. For example, some current VR, MR, and AR devices have a field of view somewhere between 30 and 40°.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a movement based display configured to display full images to a user by moving light emitters through a user's field of view. The movement based display includes a first movable member. The movement based display further includes a first light emitter array, comprising a plurality of light emitters, coupled to the first movable member. The first light emitter array is configured to output light from the light emitters dependent on a position of the first movable member. The movement based display further includes a first lens array. The first lens array is coupled to the first light emitter array. The first lens array comprises lenses configured to direct light into a first aperture, such as a user's eye.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a movement based display device;

FIG. 2A illustrates a movable member, light emitter array and lens array of a movement based display device;

FIG. 2B illustrates additional details of a movable member, light emitter array and lens array of a movement based display device;

FIG. 3A illustrates one example of a light emitter array;

FIG. 3B illustrates another example of a light emitter array;

FIG. 4A illustrates a movement based display device with a movable member configured to rotate about a user's head;

FIG. 4B illustrates a movement based display device with a movable member configured to reciprocate in front of user's eyes;

FIG. 4C illustrates a movement based display device with movable members configured to spin in front of the user's eyes

FIG. 5 illustrates a method of displaying full images to a user by moving light emitters through a user's field of view; and

FIG. 6 illustrates a method of manufacturing a movement based display device.

### DETAILED DESCRIPTION

Some embodiments illustrated herein are able to implement a motion based display on a headset usable for augmented reality, mixed reality, and/or virtual reality systems. In particular, the embodiments implement a device where an array of light emitters are caused to move and output light from the light emitters in a way that causes a user to perceive an image displayed by the light emitters, that is, to display one or more images that are persisted to a user based on the motion of the light emitters, the modulation of the light emitters, and the physical perception limitations of a user. In particular, the light emitters can be moved at a sufficient speed and output from the light emitters modulated in such a way that the motion of the light emitters is substantially imperceptible to a user, thus causing the motion of the light emitters combined with the output of the light emitters to appear as a persisted image to a user. Note that the static images displayed to a user can be changed over time at a rate which can cause the static images to be used in animation. Alternatively images can be displayed with devices which include head tracking such that virtual items can be displayed to a user in a static location in a real world environment as the user moves about the real world environment. Thus for example, a one dimensional array of light emitters can be used to create a two-dimensional image. Further, as will be illustrated in more detail below, a one dimensional array of light emitters and/or a pair of one dimensional arrays of light emitters can be used to create three-dimensional images by displaying stereoscopic images to a user.

Additionally, embodiments may be implemented where the light emitter arrays are configured for use in near vision devices. For example, the light emitter arrays may be implemented in a device in a way that allows output from the light emitters in the light emitter array to be focused into a user's eye where the user's eye is in close proximity to the light emitters. For example, the light emitters may be somewhere between 0 and 4 inches from the user's eye. In some embodiments, a device may be configured for near vision use by implementing lenses on the light emitters of the light emitter array where the lenses are configured to direct light into a desired aperture, such as the pupil of a user's eye.

Such devices can improve near vision devices dramatically over existing near vision devices. For example, some embodiments may be able to provide a practically unlimited field of view.

Additionally or alternatively, some such devices may be substantially lighter weight than previous devices. Note that in some embodiments this can occur as cooling can be implemented by implementing a light emitter array on a movable member that is configured in size and shape to create convection currents which can cool light emitter elements thus obviating the need for bulky and heavy cooling elements. Additionally or alternatively, embodiments may be implemented where the light emitter array is implemented with a large surface area to facilitate cooling. Additionally or alternatively, embodiments may be implemented where moving elements inside of a device can be used as fan.

Additionally or alternatively, some such devices may be able to achieve 50/50 product weight distribution between different hemispheres of the device, for example between different hemispheres of the device. For example, there may be a desire to have even weight distribution between the front and the back of the device. In contrast, many current devices are notoriously front heavy which leads to neck strain and discomfort. Embodiments illustrated herein can be implemented to allow for a more balanced weight distribution.

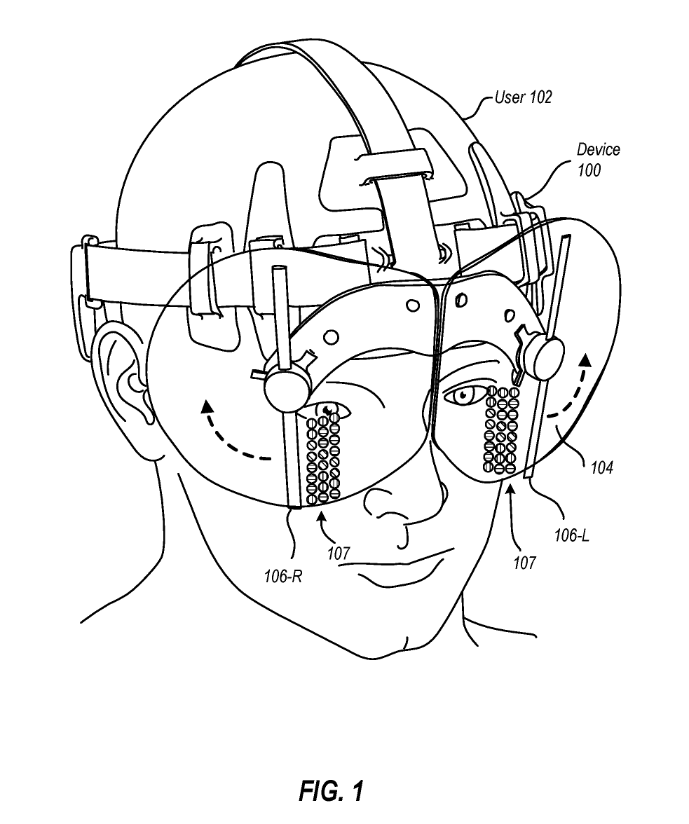

Referring now to FIG. 1, an example of a device 100 is illustrated. In this example, the device 100 is a mixed reality device which allows a user 102 to view an external environment through one or more transparent portions 104 of the device 100. Additionally, the device 100 includes one or more movable members, referred to generally as 106, but shown in FIG. 1 as 106-L and 106-R. As will be illustrated in more detail below, each movable member 106 includes a light emitter array capable of outputting light output. In particular, as the movable member's position is translated in front of the eyes of the user 102, the output of the light emitter array on the movable member 106 will be changed (i.e., modulated) such that the user 102 will perceive a persisted image, caused by the light emitter array on the movable member 106. For example, FIG. 1 illustrates sets of “dots” 107 which represent pixels flashed at specific points in time that when the dots are aggregated over time represent a persisted image.

Note that the light emitter array can be moved by the movable member 106 and produce light output, in some embodiments, in a fashion which causes one or more 2D images to be displayed to the user 102. In other embodiments, the light emitter array can be moved by the movable member 106 and produce light output in a fashion which causes one or more 3D image to be displayed to the user 102. In particular the light emitter array can direct light output into the eyes of the user 102 in a fashion such that stereoscopic images are displayed to the user 102 resulting in a 3D image being perceived by the user 102.

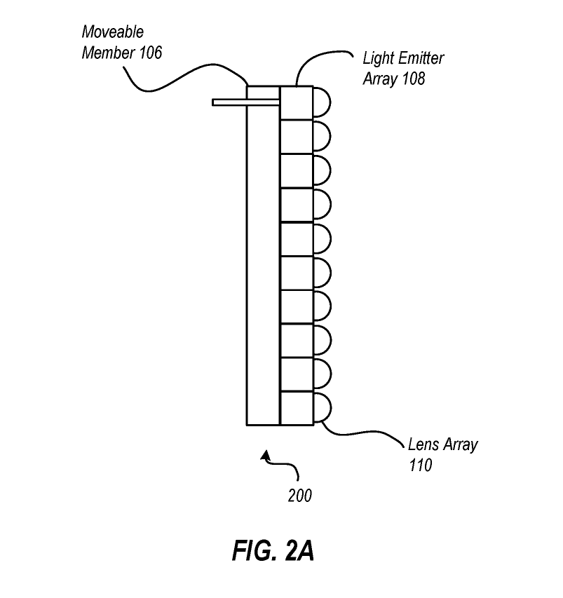

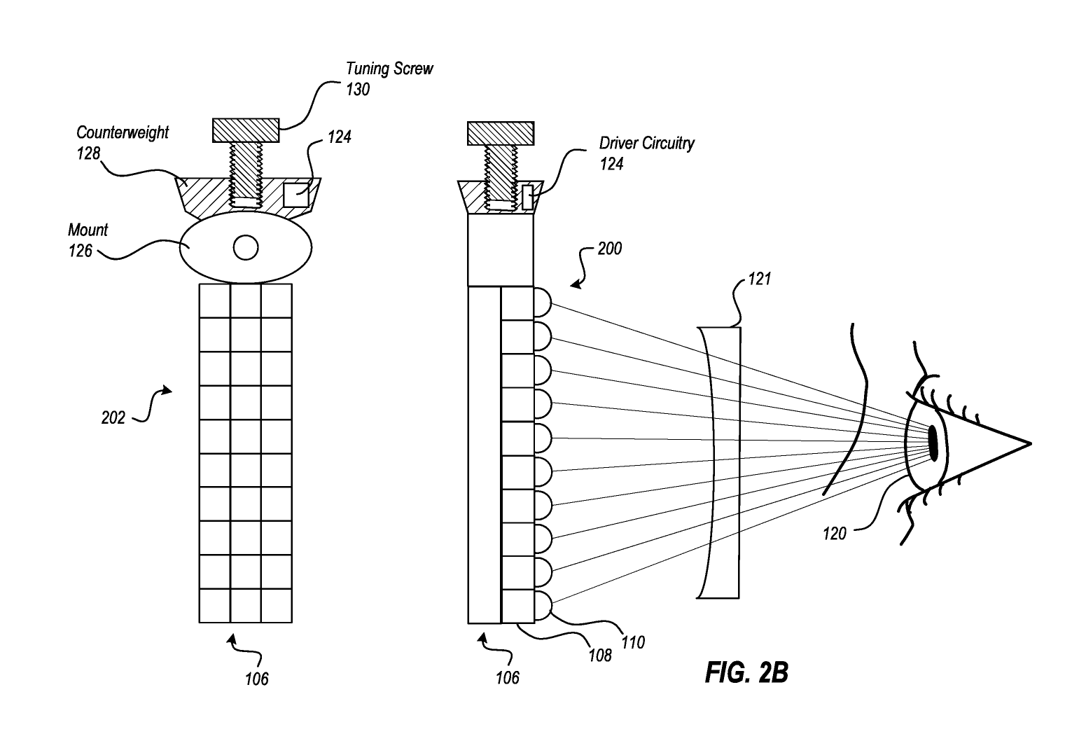

Referring now to FIG. 2A, additional details about the movable member 106, the light emitter array 108, and the lens array 110 are illustrated. FIG. 2A illustrates a side view 200 of the movable member 106 with the light emitter array 108 coupled to the movable member 106, and a lens array 110 coupled to the light emitter array 108.

The movable member 106 is a substrate on which the light emitter array 108 can be mounted. In some embodiments, the movable member is made of one or more metals and is configured to transfer and dissipate heat away from the light emitter array 108. For example, the movable member 106 may be constructed of aluminum, copper, titanium, alloys thereof, combinations thereof, or of other heat transferring materials. However, the movable member 106 may alternatively or additionally be constructed of other materials, such as polymers or other rigid or semi-rigid materials.

In some embodiments, the movable member 106 may further include a semiconductor substrate on which the light emitter array 108 can be fabricated.

As the movable member 106 physically translates when the device 100 is in operation, the movable member 106 may be configured, in some embodiments, in size and shape to create convection air currents when the movable member 106 is in motion. In particular, the movable member 106 may be configured in size and shape to cause air to flow across and/or away from the light emitter array 108 carrying heat away from the light emitter array 108.

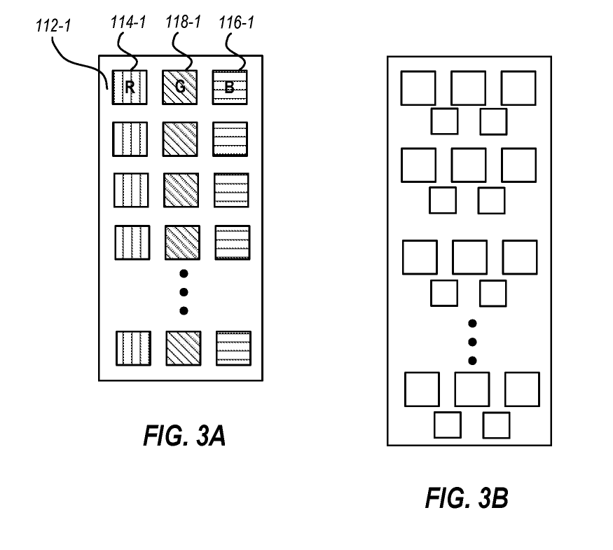

The light emitter array 108 may be composed of various light emitting sources. For example the light emitting sources of the light emitter array may include light emitting diodes (LEDs) semiconductor lasers, and/or other light emitting sources. The light emitter array 108 may be configured in any one of a number of different configurations. Various example configurations are illustrated in FIGS. 3A and 3B.

FIG. 3A illustrates an example where a light emitter array 108-A comprises a one dimensional array but where each point along the dimension includes a red light emitter, blue light emitter, and a green light emitter (or other colors as appropriate). For example, row 112-1 includes a red LED 114-1, a blue LED 116-1 and a green LED 118-1.

FIG. 3B illustrates an alternative embodiment. In FIG. 3B, a one dimensional array is still implemented, but each point along the dimension may include a plurality of red, blue, and green light emitters. In some embodiments, this can be used to control the brightness and/or color quality of light emitted from the light emitter array 108. In particular, multiple LEDs of one color or of multiple colors can be used to cause a brighter output for those colors.

The light emitters on the light emitter array 108 may have certain characteristics to obtain a desired image resolution for images persisted to the user by moving the movable member 106. For example, if there is a desire to display a 1080P image to the user 102, the light emitter array 108 may have approximately a 14 μm pixel density. Additionally or alternatively, to allow the light emitter array 108 to change light outputs sufficiently fast to create a persisted image displayed to the user 102, the light emitters in the light emitter array 108 may have a latency of about 1.5 μs or less.

The lens array 110 may be implemented in one or more of a number of different fashions. For example, in some embodiments, the lens array may include discrete lenses mechanically disposed on light emitters of the light emitter array.

Alternatively or additionally, lenses may be applied using semiconductor processing and lithographic techniques. For example, during manufacturing of the lens array 110, processes may include exposing individual light emitters by etching away portions of top layers of a semiconductor epitaxy to create rounded surfaces over each light emitter and adding a resin layer over the rounded surfaces to act as lenses for the light emitters.

Alternatively or additionally, the lens array may include diffraction gratings. For example, in a manufacturing process, fused silica may be deposited onto the light emitters of the light emitter array 108. Holographically patterned gratings can be etched into the fused silica in a fashion that causes light from the light emitters in the light emitter array 108 to be directed towards the eye of a user. Alternatively or additionally, embodiments may use digital planar holography to construct gratings in the lens array 110.

As illustrated in FIG. 2B, the lenses of the lens array 110 cause light emitted from the light emitters of the light emitter array 108 to be directed toward an aperture 120, which in the illustrated example, is the pupil of a user's eye. Note that in other embodiments, the aperture 120 may be a camera aperture, computer vision device aperture, or other appropriate aperture.

Note that the lenses may be configured specifically to focus the emitted light toward the aperture 120. In particular in near vison devices, there is a need to focus emitted light into a pupil rather than just allowing diffused light to enter the pupil. Thus, as used herein, directing light into an aperture requires the light to be focused or concentrated into the aperture. In some embodiments, directing light into an aperture may require that a certain percentage of the light be directed towards and enter the aperture. For example, some embodiments may require that at least 90% of the emitted light be directed towards and enter into the aperture. Alternatively or additionally, embodiments may require that at least 70% of the emitted light be directed towards and enter into the aperture. Alternatively or additionally, some embodiments may require that at least 50% of the emitted light be directed towards and enter into the aperture.

Note that in some embodiments, the lens array 110 may be used in conjunction with an additional lens or additional lenses, such as the lens 121 illustrated in FIG. 2B, to accomplish the acts of directing light into an aperture or for shifting the focal distance.

FIG. 2B further illustrates driver circuitry 124 disposed on the movable member 106. The driver circuitry 124 is configured to drive the light emitters on the light emitter array 108. In particular, the driver circuitry 124 may include various power circuits configured to drive the light emitters on the light emitter array 108. In some embodiments, the driver circuitry 120 were may be coupled to power sources such as batteries, hardwired electrical sources, combinations thereof, and the like. The driver circuitry 124 may further include circuitry configured to modulate the light emitters on the light emitter array 108 in a way to create a persisted image based on the movement of the movable member 106 and the limitations of the user perceiving the movement. In particular, the driver circuitry 124 may be configured to vary the output of the light emitters of the light emitter array 108 as the movable member 106 moves to create a perception of a persisted image to user 102.

In some embodiments, the driver circuitry 124 may also include computing circuitry to perform various general-purpose computing tasks. For example, the driver circuitry 124 may include the ability to run word processing applications, photo editing applications, email applications, Internet browsing applications, or any one of a number of different applications. Alternatively or additionally, in some embodiments the driver circuitry 124 may be configured to connect to external computing circuitry to receive data used for creating the persisted images displayed to the user 102.

In some embodiments, the driver circuitry 124 may be configured to receive wireless data from sources external to the device 100. For example, consider a scenario where the user wearing the device 100 is able to move about a physical environment. Items in the physical environment may include, or be associated with, wireless transmitters that are able to transmit data to the wireless device driver circuitry 124 through wireless communication means. For example, consider a case where a user may be in museum or other such facility. As the user moves from exhibit to exhibit, the user can view exhibit items at the location of the exhibit items. A wireless transmitter may transmit data describing various features of the exhibit item. As the user moves to a new exhibit item, information can be transmitted from a transmitter proximate that new item which provides details regarding the new item.

Note that embodiments may be implemented where the output from the light emitter array 108 is directed to an eye box having a particular field of view 109. Field of view is defined as the number of viewable angles of an aperture. Typically, when referring to field-of-view in virtual reality, augmented reality, and mixed reality devices, field-of-view refers to the number of viewable angles for a particular fixation of an eye. Due to the movable nature of the movable member 106 and associated light and optical components, embodiments are able to direct light in a way that is able to expand the field of view 109 over currently existing devices. In particular, some embodiments may be able to implement a field-of-view of about 80 to 90° where previous systems have been limited to about 30 to 40°.

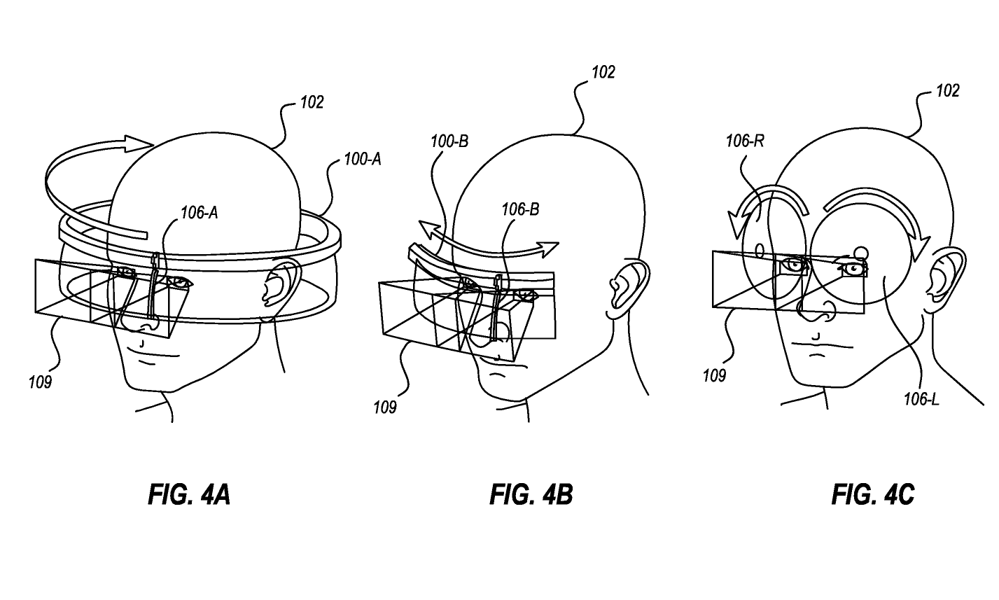

Referring now to FIGS. 4A through 4C, various alternative embodiments are illustrated. In particular, the embodiments illustrated in FIGS. 4A through 4C illustrate various different examples of how the position of a movable member may be translated on a device.

FIG. 4A illustrates an example where the movable member 106-A is configured to rotate about the head of the user 102 on a track implemented on the device 100-A. In this example, the movable member 106-A runs on a track of the device 100-A in a fashion that allows the movable member 106-A spin around the user's head. The movable member 106-A spins at a rate sufficient to create one or more persisted images for the user 102. In particular, movable member 106-A will rotate about the user's head while output from a light emitter array is modulated based on the position of the movable member 106-A so as to create one or more persisted images for the user 102. In some embodiments, the light emitter array on the movable member 106-A may be modulated in a fashion that allows stereoscopic images to be displayed to the user 102 to create a 3D image effect for the user 102. For example, as the movable member 106-A passes a user's left eye, one image of a pair of stereoscopic images will be perceived by the user 102 and as the movable member 106-A passes a user's right eye, the other image of the pair of stereoscopic images will be perceived by the user 102.

Note that while in the example illustrated in FIG. 4A a single rotational member 106-A is illustrated, it should be appreciated that in other embodiments multiple movable members may be implemented. In particular, in some embodiments it may be useful to have the members rotate about the user's head in different directions for the purpose of counteracting the gyroscopic effects that may occur by having a single movable member implemented on the device 100-A. Embodiments may be implemented where one of the movable members includes a light emitter array and the other movable member does not include a light-emitting array but is simply for counteracting gyroscopic effects. However, in other embodiments, both of the movable members may include light emitter arrays. In this example, the different light emitter arrays can be used to control brightness, or for other purposes. For example, in some embodiments, one light emitter array may be used for each eye.

FIG. 4B illustrates another example of a device 100-B. In the example illustrated in FIG. 4B, the movable member 106-B reciprocates in front of the eyes of the user 102. That is, the movable member 106-B moves back and forth in front of the user's eyes. The movable member 106-B moves at a sufficient rate, in conjunction with modulation of light output of a light emitter array, and the characteristics of a user's perception, to create one or more persisted images viewable by the user 102. Note that in some embodiments, different persisted images may be displayed at two different eyes of the user 102 to create a stereoscopic effect allowing for the display of 3D images to the user 102.

Note again that while a single movable member 106-B is illustrated, it should be appreciated that in other embodiments, multiple movable members may be implemented. For example, in some embodiments a movable member may be implemented for each eye. In some embodiments the motion of the movable members, when multiple movable members are implemented, are coordinated so as to reduce or eliminate any jarring effects that may be experienced by the user resulting from the motion of the movable members. Thus for example, the movable members may be configured to move in opposite directions and to reach the end of their motions at about the same time so as to cause movements and/or abrupt stops to cancel each other.

Referring now to FIG. 4C, yet another illustrative embodiment is illustrated. In this example, movable members 106-R and 106-L are configured to spin in front of the right and left eyes respectively of the user 102. Light emitter arrays coupled to the movable members 106-R and 106-L are configured to be modulated in a fashion to output persisted images to the user's eyes as the movable members 106-R and 106-L spin in front of the user's eyes. This can be used to create one or more persisted images to the user 102. Note that the movable members 106-R and 106-L may be moved in a fashion where the members spin in opposite directions so as to counteract motion effects that might otherwise be perceived by the user 102.

Returning once again to FIG. 2B, additional details with respect to the movable member 106 are illustrated. The movable member 106 illustrated in FIG. 2B is an example of a movable member that might be implemented in the device 100-C illustrated in FIG. 4C. In particular, the movable member 106 includes a mount 126 configured to connect to a motor which causes the movable member 106 to spin about an axis on the mount 126. Note that it is desirable to have the movable member 106 spin in a way where jarring vibration effects are reduced or eliminated. Thus, in the example illustrated in FIG. 2B, the movable member 106 also includes a counterweight 128. The counterweight 128 is configured to cause the center of the mount 126 to be the center of gravity for the movable member 106. Note that in some embodiments this may be tunable by the use of a tuning screw 130. The tuning screw 130 may be adjusted in the counterweight 128 by threading the screw into the counterweight 128 or out of the counter weight 128 as appropriate so as to tune the location of the center of gravity on the mount 126. Note that in some embodiments, the tuning screw 130 may be adjusted during the manufacturing process of the device 100. Alternatively or additionally, in some embodiments the tuning screw 130 may be user adjustable to allow users to manually tune the location of the center of gravity of the movable member 106.

Note that while a screw is illustrated herein, other embodiments may use other functionality, such as sliding weights, removable (or addable) tabs, adjustable pivot points, or any one of a number of different methods for balance the moveable member 106.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

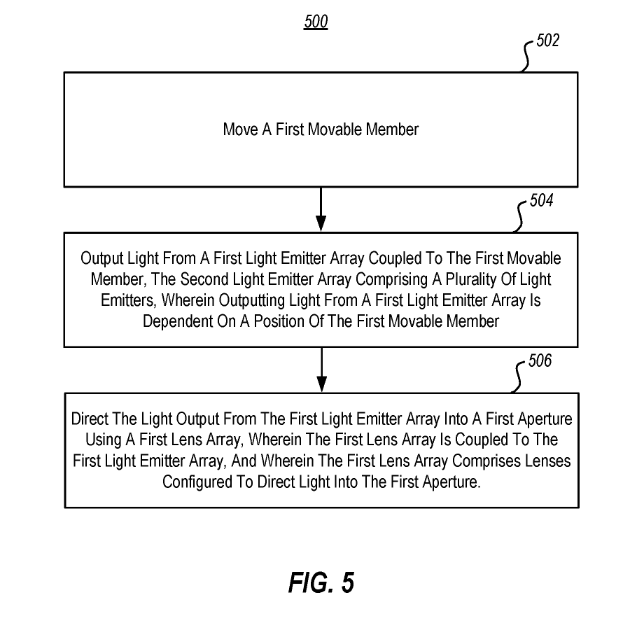

Referring now to FIG. 5, a method 500 is illustrated. The method 500 includes acts for displaying full images to a user by moving light emitters through a user's field of view. The method includes moving a first movable member (act 502). For example, as illustrated in FIG. 4A, the movable member 106-A may be moved. As illustrated in FIG. 4B, the movable member 106-B may be moved. As illustrated in FIG. 4C, the movable members 106-R and 106-L may be moved.

The method 500 further includes outputting light from a first light emitter array coupled to the first movable member, the first light emitter array comprising a plurality of light emitters, wherein outputting light from a first light emitter array is dependent on a position of the first movable member (act 504). For example, as illustrated in FIG. 2B, the light emitter array 108 may emit light based on the position of the movable member 106.

The method 500 further includes directing the light output from the first light emitter array into a first aperture using a first lens array, wherein the first lens array is coupled to the first light emitter array, and wherein the first lens array comprises lenses configured to direct light into the first aperture (act 506). For example, as illustrated in FIG. 2B, the lens array 110 may direct the light into in aperture 120, which in this case is a user's eye, and more particularly, the pupil of a user's eye.

The method 500 may be practiced where moving the first movable member comprises rotating the first movable member about an axis. An example of this is illustrated in FIG. 4C. As discussed previously, FIG. 2B illustrates a mount 126 is configured to allow the movable member 106 to rotate about an axis in the movable mount 126.

The method 500 may be practiced where directing the light output from the first light emitter array into a first aperture comprises directing the light output from the first light emitter array into an eye of a user.

The method 500 may be practiced where directing the light output from the first light emitter array into a first aperture comprises directing the light through a lens configured to work in conjunction with the first lens array to direct light into the aperture. For example, as illustrated in FIG. 2B, a lens 121 may be used in conjunction with the lens array 110 to direct light into an appropriate aperture, such as the aperture 120, which in this case is a user eye.

The method 500 may further include, using the movement of the first movable member to cool the first light emitter array.

The method 500 may be practiced where outputting light from a first light emitter array coupled to the first movable member is performed using driver circuity coupled to the light emitter array, wherein the driver circuitry configures the light emitter array to output light from the light emitters dependent on a position of the first movable member. In some such embodiments, the method 500 may further include the driver circuitry wirelessly receiving data for configuring the light emitter array.

The method 500 may further include moving a second movable member, outputting light from a second light emitter array coupled to the second movable member, the second light emitter array comprising a plurality of light emitters, wherein outputting light from a second light emitter array is dependent on a position of the second movable member, and directing the light output from the second light emitter array into a second aperture using a second lens array, wherein the second lens array is coupled to the second light emitter array, and wherein the second lens array comprises lenses configured to direct light into the second aperture such that the first light emitter array and second light emitter array display a 3D image to a user. One example of this is illustrated in FIG. 4C where two movable members are illustrated. However, it should be appreciated that the embodiments illustrated in FIG. 4A, and FIG. 4B may also include an additional movable member such that a movable member is included for each eye.

It should also be appreciated however, that in some embodiments a single movable member may be able to transmit output 3D images by outputting different images of a stereoscopic pair of images two different eyes of the user.

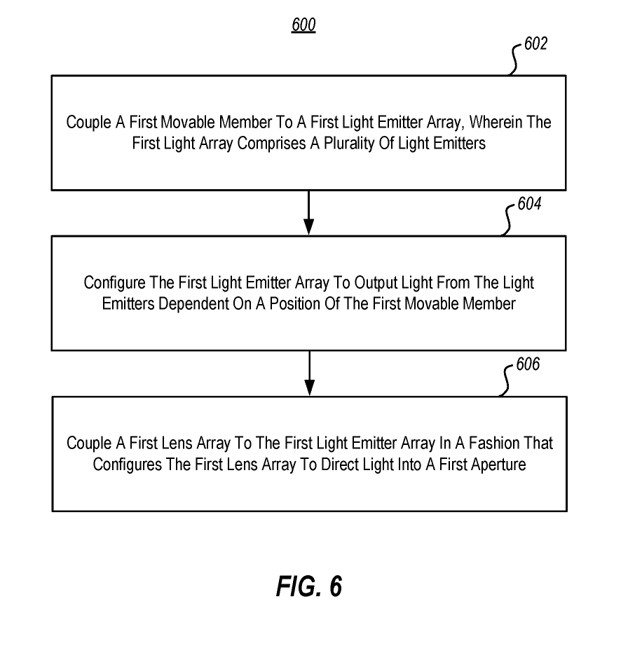

Referring now to FIG. 6, a method 600 is illustrated. The method 600 includes acts for manufacturing a movement based display device configured to display full images to a user by moving light emitters through a user's field of view. The method 600 includes coupling a first movable member to a first light emitter array, wherein the first light array comprises a plurality of light emitters (act 602). For example, FIG. 2B illustrates a movable member 106 with a light emitter array 108 coupled to the movable member 106. The light emitter array 108 may be coupled to the movable member 106 in one or more of a number of different fashions. For example, in some embodiments, the light emitter a 108 may be formed by various semi-conductor processes on a portion of the movable member 106 that is made up of a semiconductor substrate. Alternatively or additionally, the light emitter a 108 may be fastened to the movable member 106 using various adhesives, glues, mechanical fasteners (such as screws, rivets, and the like).

The method 600 further includes configuring the first light emitter array to output light from the light emitters dependent on a position of the first movable member (act 604). For example, the light emitter are a 108 may be coupled to driver circuitry 124 which configures the light emitter are a 108 to modulate its output according to a position of the movable member 106. Thus, the light output from the light emitter are a 108 will vary depending on the position of the movable member 106.

The method 600 further includes coupling a first lens array to the first light emitter array in a fashion that configures the first lens array to direct light into a first aperture (act 606). For example, as illustrated in FIG. 2B, a lens array 110 is coupled to the light emitter of a 108. As noted above, the lens array 110 may be coupled to the light emitter of a 108 in various fashions including mechanical fastening or by forming the lens array 110 on the light emitter array 108 using various epitaxial processes.

The method 600 may further include configuring the first movable member to rotate about an axis.

The method 600 may further include optically coupling a lens configured to the first lens array to work in conjunction with first lens array to direct light into the aperture. For example, as illustrated in FIG. 2B, a lens 121 is optically coupled to the lens array 110 to assist in directing light output from the light emitter of a 108 into in aperture 120, which in this case is a user's eye, and more particularly in some embodiments, the aperture may be the pupil of a user's eye.

The method 600 may further include coupling a second movable member to a second light emitter array, wherein the second light array comprises a second plurality of light emitters, configuring the second light emitter array to output light from the second plurality of light emitters dependent on a position of the second movable member, and coupling a second lens array to the second light emitter array in a fashion that configures the second lens array to direct light into a second aperture such that the first light emitter array and second light emitter array are configured to display a 3D image to a user. This can be used to create a device such as the one illustrated in FIG. 4C where two movable members 106-R and 106-L are used to output optical data to the user 102.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A movement based display device configured to display full images to a user by moving light emitters through a user's field of view, the movement based display device comprising:
a first movable member;
a first light emitter array, comprising a plurality of light emitters, coupled to the first movable member, wherein the first light emitter array is configured to output light from the light emitters dependent on a position of the first movable member; and
a first lens array, wherein the first lens array is coupled to the first light emitter array, and wherein the first lens array comprises lenses configured to direct light into a first aperture.

2. The movement based display device of claim 1, wherein the first movable member is configured to rotate about an axis.

3. The movement based display device of claim 1, wherein the first aperture comprises an eye of a user.

4. The movement based display device of claim 1, further comprising a lens configured to work in conjunction with the first lens array to direct light into the aperture.

5. The movement based display device of claim 1, wherein the first movable member is configured in size and shape to provide cooling to the first light emitter array when the first movable member is in motion.

6. The movement based display device of claim 1, further comprising driver circuity coupled to the light emitter array, wherein the driver circuitry configures the light emitter array to output light from the light emitters dependent on a position of the first movable member.

7. The movement based display device of claim 6, wherein the driver circuitry comprises wireless circuitry configured to receive data wirelessly.

8. The movement based display device of claim 1, further comprising:
a second movable member;
a second light emitter array, comprising a plurality of light emitters, coupled to the second movable member, wherein the light emitter array is configured to output light from the light emitters dependent on a position of the second movable member;
a second lens array, wherein the second lens array is coupled to the second light emitter array, and wherein the lens array comprises lenses configured to direct light into a second aperture; and
wherein the first light emitter array and second light emitter array are configured to display a 3D image to a user.

9. A method of displaying full images to a user by moving light emitters through a user's field of view, the method comprising:
moving a first movable member;
outputting light from a first light emitter array coupled to the first movable member, the second light emitter array comprising a plurality of light emitters, wherein outputting light from a first light emitter array is dependent on a position of the first movable member; and
directing the light output from the first light emitter array into a first aperture using a first lens array, wherein the first lens array is coupled to the first light emitter array, and wherein the first lens array comprises lenses configured to direct light into the first aperture.

10. The method of claim 9, wherein moving the first movable member comprises rotating the first movable member about an axis.

11. The method of claim 9, wherein directing the light output from the first light emitter array into a first aperture comprises directing the light output from the first light emitter array into an eye of a user.

12. The method of claim 9, wherein directing the light output from the first light emitter array into a first aperture comprises directing the light through a lens configured to work in conjunction with the first lens array to direct light into the aperture.

13. The method of claim 9 further comprising, using the movement of the first movable member to cool the first light emitter array.

14. The method of claim 9, wherein outputting light from a first light emitter array coupled to the first movable member is performed using driver circuity coupled to the light emitter array, wherein the driver circuitry configures the light emitter array to output light from the light emitters dependent on a position of the first movable member.

15. The method of claim 14, further comprising the driver circuitry wirelessly receiving data for configuring the light emitter array.

16. The method of claim 9 further comprising:
moving a second movable member;
outputting light from a second light emitter array coupled to the second movable member, the second light emitter array comprising a plurality of light emitters, wherein outputting light from a second light emitter array is dependent on a position of the second movable member; and
directing the light output from the second light emitter array into a second aperture using a second lens array, wherein the second lens array is coupled to the second light emitter array, and wherein the second lens array comprises lenses configured to direct light into the second aperture such that the first light emitter array and second light emitter array display a 3D image to a user.

17. A method of manufacturing a movement based display device configured to display full images to a user by moving light emitters through a user's field of view, the method comprising:
coupling a first movable member to a first light emitter array, wherein the first light array comprises a plurality of light emitters;
configuring the first light emitter array to output light from the light emitters dependent on a position of the first movable member; and
coupling a first lens array to the first light emitter array in a fashion that configures the first lens array to direct light into a first aperture.

18. The method of claim 17 further comprising, configuring the first movable member to rotate about an axis.

19. The method of claim 17, further comprising optically coupling a lens configured to the first lens array to work in conjunction with first lens array to direct light into the aperture.

20. The method of claim 17, further comprising:
coupling a second movable member to a second light emitter array, wherein the second light array comprises a second plurality of light emitters;
configuring the second light emitter array to output light from the second plurality of light emitters dependent on a position of the second movable member; and
coupling a second lens array to the second light emitter array in a fashion that configures the second lens array to direct light into a second aperture such that the first light emitter array and second light emitter array are configured to display a 3D image to a user.
